(19) United States
(12) Patent Application Publication
(10) Pub. No.: US 2007/0275820 A1
(43) Pub. Date: Nov. 29, 2007

(54) Drive Train With Exhaust Gas Utilization and Control Method

(76) Inventors: Markus Kley, Ellwangen (DE); Reinhold Pittius, Crailsheim (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/583,911

(22) PCT Filed: Nov. 26, 2004
(86) PCT No.: PCT/EP04/13407

§ 371 Date: May 21, 2007

(30) Foreign Application Priority Data
Dec. 20, 2003 (DE) 10360155.4

(51) Int. Cl. F02C 7/36

(52) U.S. Cl. 477/30

(57) ABSTRACT

The invention relates to a drive train, comprising an internal combustion engine, an exhaust gas turbine, arranged in the flow of exhaust of the internal combustion engine, a crankshaft driven by the internal combustion engine, switchably connected by means of a hydrodynamic coupling to the exhaust gas turbine in driven connection such that the crankshaft is driven by the turbine, said hydrodynamic coupling comprising a primary impeller and a secondary impeller which together form a working chamber which may be filled with a working medium for torque transfer, the primary impeller being in driven connection with the exhaust gas turbine; the secondary impeller is in driven connection with the crankshaft; the primary impeller may be mechanically braked and locked in relation to a rotational movement such that the hydrodynamic coupling assumes a hydrodynamic retarding function. The drive train according to the invention is characterized in that a control is provided which, prior to and/or during a braking of the primary impeller, empties the working chamber of the hydrodynamic coupling to a given level of filling.

The invention concerns a drive train, in particular, a drive train for a motor vehicle, in which the exhaust gas energy of the exhaust of an internal combustion engine is utilized for driving by means of an exhaust gas turbine. Further, the invention concerns a method for controlling such a drive train.

The use of exhaust gas turbines in drive trains, in particular in drive trains for motor vehicles, is known. According to a known type, in the operation for utilizing the exhaust gas energy, the crankshaft of the internal combustion engine is additionally driven by the exhaust gas turbine, which is connected to the crankshaft in a suitable driven connection. The driven connection comprises a hydrodynamic coupling, which transfers the drive torque of the exhaust gas turbine to the crankshaft. Suitable transmissions or gears can also be connected in between.

According to a further development of this type, the hydrodynamic coupling serves not only for the torque transfer in the operation for utilizing the exhaust gas energy, but it is also used as a hydrodynamic brake, i.e., as a so-caller retarder. For this purpose, one impeller of the hydrodynamic coupling is made mechanically stationary, usually the impeller that is associated with the exhaust gas turbine. Alternatively, operation may also be conducted with two different hydraulic circuits, which fill up and empty a coupling space and a retarder space in a targeted manner.

As a means for braking or making stationary the one wheel of the hydrodynamic coupling, for example, a multiplate coupling can be used. In the case of such multiplate couplings, however, technical problems always arise, which for the most part have been attributed to overloading. Correspondingly, multiplate couplings have been designed as powerful units, i.e., with large structural dimensions and a heavy weight. On the one hand, this design leads to high costs. On the other hand, the additional weight, in particular, in motor vehicles, is to be viewed as a disadvantage, since nowadays, as is known, one strives to minimize fuel consumption.

The object of the invention is to further develop a drive train with an internal combustion engine, an exhaust gas turbine, and a hydrodynamic coupling in the driven connection between a crankshaft and the exhaust gas turbine, wherein the hydrodynamic coupling is also used for hydrodynamic braking, in such a way that the disadvantages of the prior art are eliminated. In particular, a structurally smaller means, especially a multiplate coupling, will be able to be used for braking or locking the one coupling impeller. In addition, a control method for controlling the drive train according to the invention will be presented.

The object according to the invention is achieved by a drive train and a control method for a drive train according to the independent claims. The subdlaims describe particularly advantageous enhancements of the invention.

The inventor has recognized one possibility for designing a drive train of the type described, in which the hydrodynamic coupling can be designed for high transfer power and at the same time, only a comparatively small braking or locking device can be used for the braking and locking of a blade wheel of the hydrodynamic coupling, without the existence of a danger of overloading. In the drive train according to the invention, the regions of highest load peaks, so to speak, are removed from the operating program. In this way, on the one hand, the coupling is taken care of, and, on the other hand, when used in a motor vehicle, travel comfort is increased by a smoother transition from coupling operation to retarder operation. This is accomplished according to the invention by providing a control, which empties the working chamber of the hydrodynamic coupling to a prespecified level of filling, prior to the braking of the primary impeller, i.e., the blade wheel which is assigned to the exhaust gas turbine and is used as the stator in the retarder operation. Alternatively or additionally, emptying can be produced together with the braking of the primary impeller of the hydrodynamic coupling. It is only important that the emptying is conducted in a timely manner, so that load states which exceed the power capacity of the braking device do not last a long time or, in general, do not occur at all.

According to an advantageous embodiment, the braking device for braking and mechanical locking of the primary impeller of the hydrodynamic coupling is a multiplate coupling. It is also advantageous, if the hydrodynamic coupling is disposed in the cooling circuit of a vehicle and the working medium is the vehicle cooling medium, in particular, water or a water mixture.

For the targeted emptying of the working chamber of the hydrodynamic coupling prior to or during the braking of the primary impeller, various designs can be applied. According to one embodiment, a 3/2-directional control valve is disposed in the cooling circuit in front of the hydrodynamic coupling, and when the primary impeller is not braked, i.e., in “normal” travel operation, this valve distributes the flow of working medium which is introduced in the direction of the hydrodynamic coupling and, at the same time, in the direction of the internal combustion engine, which is cooled by the working medium or the cooling medium, respectively. Directly prior to braking and/or during braking of the primary impeller, the 3/2- directional control valve is switched off and blocks the flow of working medium in the direction of the hydrodynamic coupling, so that without a flow into it, the working chamber of the hydrodynamic coupling is emptied by the continued outflow to the desired level of filling.

Alternatively or additionally, a throttling site can be provided in the flow direction in front of the hydrodynamic coupling, and this site throttles the flow of working medium prior to the braking or during the braking of the primary impeller. This throttling site can be designed in the form of a regulated choke or as a choke that can be switched on, for example, in a bypass.

Alternatively or additionally, in order to increase the speed of emptying, an enlargeable discharge opening or additional discharge openings can be provided in the flow direction behind the hydrodynamic coupling, by means of which the flow cross section that is made available is widened prior to braking or during braking of the primary impeller of the hydrodynamic coupling.

The method according to the invention is characterized by at least three steps:

In the operation for utilizing exhaust gas energy, i.e., in an operating state, in which exhaust gas energy is converted to rotational energy by means of the exhaust gas turbine and is used for the (additional) driving of the crankshaft, the working chamber of the hydrodynamic coupling is maintained substantially filled or is kept completely filled and, corresponding to the desired coupling function, i.e., the transfer of the desired torque from the exhaust gas turbine to the crankshaft, none of the coupling blade wheels, i.e., neither the primary impeller nor the secondary impeller, is mechanically braked. In the retarder braking operation, i.e., in the operating state, in which the primary impeller of the hydrodynamic coupling is mechanically locked against rotation and the hydrodynamic coupling operates as a retarder, the working chamber of the hydrodynamic coupling is maintained at a prespecified level of filling, which is usually smaller than the level of filling in the coupling operation, i.e., in the operation for utilizing the exhaust gas energy. As in the case of conventional hydrodynamic couplings, a partial filling is also possible in the coupling operation, of course, under certain operating conditions, and, as in the case of conventional retarders, a complete filling in the retarder operation.

Upon switching from the operation for utilizing the exhaust gas energy to the retarder operation, the working chamber of the hydrodynamic coupling is emptied to a prespecified level of filling. The switchover begins with the braking of the primary impeller of the hydrodynamic coupling or even prior to that in the case of an emptying directly prior to the beginning of braking of the primary impeller.

In order to be able to design the braking or locking device so that it is especially small, the working chamber of the hydrodynamic coupling is completely emptied during the switchover. However, it is often sufficient if only a partial emptying takes place.

As long as the hydrodynamic coupling is operated with a partial filling in the retarder operation, for example, in order to adjust the optimal braking power, there are two possibilities for “starting up” this partial filling state. According to the first possibility, this filling state of the retarder operation commences directly prior to or during the braking of the primary impeller of the hydrodynamic coupling. According to the second possibility, a filling state commences, which has a level of filling that is smaller than that of the retarder operation. Correspondingly, the coupling is subsequently filled again up to the level of filling of the retarder operation.

The invention will be explained in more detail below on the basis of an embodiment example.

Herein is shown:

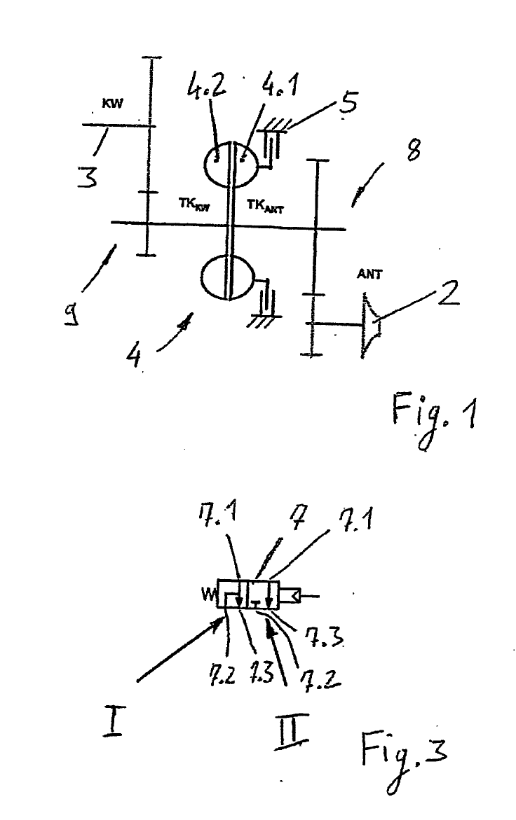

FIG. 1 a structure, in principle, of the driven connection between the exhaust gas turbine and the crankshaft;

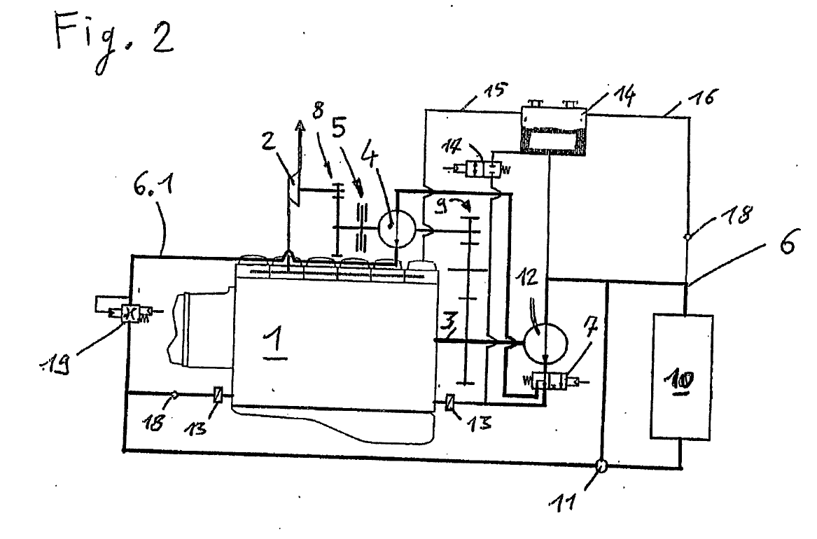

FIG. 2 a control diagram for the control of a drive train according to the invention;

FIG. 3 the states of the 3/2-directional control valve shown in FIG. 2 in detail.

Shown in FIG. 1 is the driven connection between an exhaust gas turbine 2 and a crankshaft 3 of an internal combustion engine (not shown), which is designed according to an embodiment of the present invention. The driven shaft of the exhaust gas turbine is joined with the primary impeller 4.1 of the hydrodynamic coupling 4 via a first gear 8. The crankshaft 3 is joined with the secondary impeller 4.2 of the hydrodynamic coupling 4 via a second gear 9. Correspondingly, during a filling of the working chamber of the hydrodynamic coupling 4, preferably with a complete filling, the torque or the rotational power, respectively, of the exhaust gas turbine 2 is transferred to the crankshaft 3.

In order to generate a braking torque, the primary impeller 4.1 of the hydrodynamic coupling 4 can be braked and mechanically locked by means of the multiplate coupling 5. This locking has two effects in the present embodiment: First of all, the hydrodynamic coupling 4 acts as a retarder, i.e., the crankshaft 3 drives the secondary impeller 4.2 of the hydrodynamic coupling via the gear 9 in turn, via the filled working chamber of the hydrodynamic coupling 4, advantageously filled with a prespecified partial filling, torque is transferred from the secondary impeller 4.2 to the primary impeller 4.1 and drawn off via the multiplate coupling 5. In this way, a braking effect is produced, which brakes the crankshaft 3.

The second effect can be seen in the fact that the multiplate coupling 5, via the primary impeller 4.1 and the gear 8, also makes stationary the rotors of the exhaust gas turbine 2. Correspondingly, the flow of exhaust gas, which flows through the exhaust gas turbine, is throttled, which leads to an increased exhaust gas pressure, which in turn brakes the internal combustion engine (not shown). One could compare this effect with that of an exhaust brake or engine retarder.

A control diagram for a possible controlling of the drive train according to the invention or a possible control method according to the invention, respectively, is shown in FIG. 2. The same reference numbers are used for the components which have already been shown in FIG. 1, so that their description need not be repeated.

The hydrodynamic coupling 4 is disposed in a cooling circuit 6 of a vehicle. A cooler 10 is connected in cooling circuit 6 for cooling the cooling medium, which is simultaneously the working medium of the hydrodynamic coupling, preferably water or a water mixture. If cooling is not necessary, the latter may be bypassed via the bypass which is shown. The output values of a thermostat 11 are drawn on for distributing the corresponding flow of cooling medium, either through the cooler 10 or through the bypass.

The cooling medium or the working medium is circulated by means of the cooling water pump 12 in the cooling circuit. As can be seen, only a single cooling water pump 12 is provided in the entire cooling circuit.

In addition, other known components of a conventional cooling circuit are shown, for example, the temperature sensors 13 in front of and behind the engine 1 cooled by the cooling medium, a compensating reservoir 14, into which the engine vent 15 and the cooler vent 16 open up, a 2/2-directional control valve 17, which conducts cooling medium from the compensating reservoir into the cooling circuit as needed, as well as various non-return valves.

In the direction of flow, behind the cooling water pump 12, a 3/2-directional control valve 7 is provided, which distributes the flow of cooling medium or of working medium in two directions, namely in the direction of the hydrodynamic coupling 4 and in the direction of engine 1. Now, if the working chamber of the hydrodynamic coupling 4 is to be emptied in a targeted manner, wherein emptying is also to be understood as an emptying down to a partial filling as well as a complete emptying, the control valve 7 is switched from the position shown (in the direction to the left in the drawing), so that the flow of working medium is interrupted in the direction of the hydrodynamic coupling 4. Correspondingly, the working chamber of the hydrodynamic coupling 4 is emptied, and this is done via branch 6.1 of the line for the cooling circuit 6, into which the discharge control valve 19 is switched.

The effective flow cross section of the line which discharges the working medium from the hydrodynamic coupling 4, can be adjusted by means of the discharge control valve 19. The discharge control valve 19 can thus be disposed advantageously directly at the hydrodynamic coupling 4 or in the hydrodynamic coupling 4, but it is also possible to dispose the discharge control valve 19 in a line conducting working medium arranged behind the hydrodynamic coupling 4. By enlarging the effective flow cross section by means of the discharge control valve 19, the rate of outflow or the volume of outflow, respectively, of the working medium from the hydrodynamic coupling 4 can be increased, which leads to a more rapid emptying of the working chamber of the hydrodynamic coupling 4.

As has already been presented, the discharge control valve 19 is not absolutely necessary for the control according to the invention, but represents only one option for a more rapid emptying. Instead of the use of a switching valve or a 3/2-directional control valve 7, a choke (not shown) could also be used for emptying the working chamber of the hydrodynamic coupling 4. In this case, there would be a continuous flow into the working chamber of the hydrodynamic coupling 4, which would be throttled in a targeted manner correspondingly in the switchover from the coupling operation to the retarder operation.

The 3/2-directional control valve 7 is shown once more separately in FIG. 3. As can be seen, it has two switching positions, namely the switching position I, in which the flow of working medium introduced via the connection 7.1 is distributed to both outlets 7.2 and 7.3, wherein outlet 7.2 leads to the hydrodynamic coupling 4 and outlet 7.3 leads to the internal combustion engine 1, as is shown in FIG. 2. In switching position II, the working medium introduced via the outlet 7.1 is guided exclusively to outlet 7.3, i.e., in the direction of the internal combustion engine 1, while outlet 7.2 is blocked.

During travel, in coupling operation, in particular, twelve liters per minute are conducted in the direction of the hydrodynamic coupling 4, i.e., via the outlet 7.2. During braking in the retarder operation of the hydrodynamic coupling, advantageously, 400 liters per minute are conducted to the hydrodynamic coupling.

When switching over from the operation for utilizing the exhaust gas energy to the retarder operation, as described, the working chamber of the hydrodynamic coupling is advantageously emptied to a prespecified level of filling prior to the mechanical braking and/or during the mechanical braking of the primary impeller of the hydrodynamic coupling. This level of filling can be determined according to a special embodiment, for example, by a prespecified time period during which the working chamber is emptied. For example, the valve 7 can be switched into position II for a specified time interval, and alternatively or additionally, the cross section of the discharge control valve 19 can be increased for a specified time period.

### List of Reference Numbers

1 Internal combustion engine
2 Exhaust gas turbine
3 Crankshaft
4 Hydrodynamic coupling
4.1 Primary impeller
4.2 Secondary impeller
5 Multiplate coupling
6 Cooling circuit
6.1 Cooling circuit branch
3/2-Directional control valve
7.1, 7.2, 7.3 Connection
8 Gear
9 Gear
10 Cooler
11 Thermostat
12 Water pump
13 Temperature sensor
14 Compensting reservoir
15 Engine vent
16 Cooler vent
17 2/2-Directional control valve
18 Non-return valve
19 Discharge control valve
I Switching position in the coupling and retarder operation
II Switching position in the switchover from the coupling to the retarder operation

1-14. (canceled)

15. A drive train, comprising:
an internal combustion engine;
an exhaust gas turbine arranged in an exhaust gas flow of said internal combustion engine;
a crankshaft being driven by said internal combustion engine;
a hydrodynamic coupling having a primary impeller and a secondary impeller, the primary and secondary impellers forming a working chamber that can be filled with a working medium for transmission of torque, said hydrodynamic coupling optionally coupling said crankshaft to said exhaust gas turbine so that said crankshaft is driven by said exhaust gas turbine, the primary impeller being in driven connection with said exhaust gas turbine, the secondary impeller being in driven connection with said crankshaft, the primary impeller being optionally mechanically braked and locked in place against rotary movement so that said hydrodynamic coupling functions as a hydrodynamic retarder; and
a control for draining the working chamber of said hydrodynamic coupling to a pre-given level of filling during a switching to a retarder operation, said hydrodynamic coupling functioning as the hydrodynamic retarder prior to and/or during braking of the primary impeller.

16. The drive train according to claim 15, further comprising a multi-disk clutch being associated with the primary impeller, said multi-disk clutch being designed for mechanical braking and locking in place the primary impeller.

17. The drive train according to claim 15, wherein said hydrodynamic coupling is arranged in a cooling circuit of a vehicle, and wherein the working medium is a vehicle cooling medium.

18. The drive train according to claim 17, further comprising a 3/2-directional control valve in the cooling circuit, said 3/2-directional control valve dividing a working medium flow in a first direction of said hydrodynamic cooupling and in a second direction of said internal combustion engine when the primary impeller is not braked, said 3/2-directional control valve interrupting the working medium flow in the first direction directly prior to braking and/or during braking of the primary impeller.

19. The drive train according to claim 17, further comprising an engageable or regulatable throttle site in an upstream flow direction of said hydrodynamic coupling, said engageable or regulatable throttle site throttling a flow of working medium into the working chamber prior to braking and/or during braking of the primary impeller.

20. The drive train according to claim 17, further comprising an engageable or regulatable outlet opening in a downstream flow direction of said hydrodynamic coupling, said engageable or regulatable outlet opening increasing a flow of working medium out of the working chamber when the working chamber is drained.

21. The drive train according to claim 20, wherein said engageable or regulatable outlet opening is a discharge control valve.

22. A process of controlling a drive train, comprising:
utilizing exhaust gas energy with a driven exhaust gas turbine to keep a hydrodynamic coupling filled with working medium to a first pre-given filling level or completely filled when neither a primary impeller or a secondary impeller of the hydrodynamic coupling are mechanically braked;
filling a working chamber of the hydrodynamic coupling to a second pre-given filling level when the primary impeller is mechanically locked in place; and
draining the working chamber to a third pre-given filling level or completely prior to mechanically braking and/or during mechanically braking of the primary impeller.

23. The process according to claim 22, wherein the second pre-given filling level is lower than the first pre-given filling level.

24. The process according to claim 23, wherein said third pre-given filling level is the same as the second pre-given filling level.

25. The process according to claim 23, wherein said third pre-given filling level is lower than the second pre-given filling level.

26. The process according to claim 22, wherein said draining step comprises throttling a flow of working medium introduced into the working chamber.

27. The process according to claim 22, wherein said draining step comprises increasing a flow of working medium discharged out of the working chamber.

28. The process according to claim 22, wherein said draining step comprises interrupting a flow of working medium introduced into the working chamber.
